(19) United States
(12) Patent Application Publication
(10) Pub. No.: US 2006/0239535 A1
(43) Pub. Date: Oct. 26, 2006

(54) Pattern defect inspection method and apparatus

(75) Inventors: Akira Takada, Tokyo (JP); Toru Tojo, Tokyo (JP)

Correspondence Address: FOLEY AND LARDNER LLP;SUITE 500, 3000 K STREET NW, WASHINGTON, DC, 20007, US

(73) Assignee: KABUSHIKI KAISHA TOPCON

(21) Appl. No.: 11/373,501

(22) Filed: Mar. 13, 2006

(30) Foreign Application Priority Data
Mar. 14, 2005 (JP) 2005-070508

(51) Int. Cl. H04N 7/18; G06K 9/00; G06K 9/62; G01N 21/00

(52) U.S. Cl. 382/145; 382/144; 382/149; 382/209; 348/125; 356/237.1

(57) ABSTRACT

A method and an apparatus for irradiating a measurement sample with an energy beam, a pattern being formed in the measurement sample, providing an optical system for detecting transmitted energy beam or reflected energy beam from the measurement sample, obtaining a pattern image, and comparing design data of the pattern and an image of the obtained image pattern to inspect a defect of the pattern formed in the measurement sample, wherein the measurement sample is a so-called photomask, a design pattern produced in producing the photomask is used as the design data of the pattern, and, in a procedure of performing inspection by comparing the obtained image and the design data, the design data is converted into an image (hereinafter referred to as wafer image) by a proper method, the wafer image being formed through a stepper used for actually forming the pattern of the photomask on a wafer, the obtained image actually measured is simultaneously converted into a wafer image by a proper method, and the defect is detected by comparing both wafer images to each other.

### TECHNICAL FIELD

The present invention relates to a method and an apparatus for inspecting a defect or defects of a pattern, and in particular a method and apparatus for inspecting the defects formed in the patterns of a mask, a wafer substrate, or the like used in producing a semiconductor device.

### RELATED ART

In a pattern constituting a large scale integrated circuit (LSI), a minimum dimension is reduced to the order of nanometers. One of main causes for decreasing a yield in an LSI production process are defects present in a mask which is used when an ultrafine pattern is exposed and transferred onto a semiconductor wafer by lithography.

Particularly, as a pattern dimension of LSI formed on the semiconductor wafer becomes finer, the dimension of the pattern defect to be detected becomes extremely small. Therefore, development of the apparatus for inspecting the extremely small defect is actively proceeding. A configuration of the pattern defect inspection apparatus which inspects the pattern by comparing design data with measured data of the mask used for producing the large-scale LSI is illustrated by way of example. A main part configuration and an operation will be described.

As shown in FIGS. 6-7, in a defect inspection apparatus, an inspection area in the pattern formed in a mask 1 is virtually divided into inspection stripes having widths W. The mask 1 is loaded on a table 2 shown in FIG. 7 such that the divided inspection stripes are continuously scanned, and the inspection is performed while a single axle stage is continuously moved. When the one stripe inspection is ended, another axle performs the movement in a step manner in order to observe the adjacent stripe. The pattern formed in the mask 1 is irradiated with an appropriate light source 3. The light transmitted through the mask 1 is incident on a photodiode array 5 through a magnifying optical system 4. A part of the stripe area of the virtually divided pattern is magnified on the photodiode array 5 and focused as an optical image. In the magnifying optical system 4, autofocus control is performed in order to keep the well focused state. Photoelectric conversion and A/D conversion are performed to the pattern image focused on the photodiode array 5.

On the other hand, the design data used in the pattern formation of the mask 1 is read to an expansion circuit 11 through a control computer 10. The expansion circuit 11 converts the read design data into binary or multiple-value design image data, and the expansion circuit 11 transmits the design image data to a reference circuit 12. The reference circuit 12 performs an appropriate filtering process to the graphic design image data transmitted from the expansion circuit 11.

The measurement pattern data obtained from the sensor circuit 6 is acted on by the filter due to a resolution property of the magnifying optical system 4, an aperture effect of the photodiode array 5, and the like. Therefore, the filtering process is also performed to the design image data such that the design image data conforms to the measurement image data. According to an appropriate algorithm, a comparison circuit 8 compares the measurement image data with the design image data to which the appropriate filtering process is performed. When the measurement image data and the design image data do not coincide with each other, the comparison circuit 8 determined that the defect exists.

A transmission type or a reflection type optical system is used as the optical system of this kind of the defect inspection apparatus. The inspection apparatus in which the transmitted light or the reflected light is used is disclosed in M. Tateno, et al., “Inspection capability of high-transmittance HTPSM and OPC masks for ArF lithography”, Proceeding of SPIE Vol. 5130, pp. 447-453, 2003, or in W. H. Broadbent, et al., “Results from a new reticle defect inspection plat form”, 23rd Annual BACUS Symposium on photomask Technology, Proceedings of SPIE Vol. 5256, pp. 474-488, 2003.

In the inspection with the mask defect inspection apparatus having the configuration shown in FIG. 6, difficulty and complexity of the defect detection are indicated from the following problems:

(1) Because the exposure is performed near a resolution limit in the transfer with the stepper, even the minute defect in the mask has a large influence on the pattern formation on the wafer. Therefore, improvement of defect detection sensitivity is demanded for the mask defect inspection apparatus.

(2) The resolution limit of the stepper is extended by the masks having the various structures (for example, a mask having a pattern called optical proximity effect correction pattern: OPC pattern, a phase shift mask, and the like). Therefore, in the mask defect inspection, it is necessary to develop defect detection algorithms that conform to the mask structures.

(3) Because design data capacity is largely increased by addition of the OPC pattern, data handling becomes worse in the inspection apparatus, and a significant burden is placed on a control circuit which generates the image from the design data in the conventional way.

(4) In the conventional inspection apparatus, the inspection is performed with a wavelength far away from that of the stepper. Therefore, it is impossible to ensure that the accurate inspection is performed.

An attempt to develop and use the inspection apparatus in which the inspection is performed with the wavelength as close as possible to that of the stepper is being made in order to solve the above problems, particularly in order to solve the problems of (1) and (4). However, the influence of the defect on the pattern formation on the wafer largely depends on a shape of the pattern and a position of the defect. Therefore, even if the defect dimension is uniformly specified to detect the defect on the mask, many false defects (actually false defect has no influence on the pattern formation on the wafer) are detected, which generates the problem that working of a defect correction process is largely increased. At the same time, since the OPC pattern is complex, the extremely many false defects are generated in the OPC pattern during the inspection, which results in the significant trouble in the inspection process. Further, the problem with the false defect places the burden on the development of the inspection algorithm for decreasing the false defect.

Because of the above problem, a method of directly forming the wafer image from the mask to perform the inspection is being proposed. In a method described in F. Chang and A. Rosenbusch, et al., “Aerial image-based inspection of binary (OPC) and embedded-attenuated PSM”, 22nd Annual BACUS Symposium on Photomask Technology, Proceeding of SPIE Vol. 4889, pp. 1010-1017, 2002, the optical system having the same wavelength as the stepper is provided in the inspection apparatus, and the wafer image is directly formed to perform the inspection.

Although the method described in F. Chang and A. Rosenbusch, et al. is ideal, it is necessary to have the all kinds of the inspection apparatus corresponding to the steppers used in semiconductor manufacturers, so that the generalized inspection apparatus is hardly produced. The method described in F. Chang and A. Rosenbusch, et al. is not practical, because it is necessary that the wafer image formed once be optically magnified and obtained with the sensor in order to accurately measure the minute wafer image. Even if it is found that the defect exists on the wafer, the magnifying optical system is required in order to identify the position and dimension of the defect. Therefore, it is not practical because the complicated optical system is required.

On the other hand, a method in which the wafer image is determined from the mask image obtained with the mask defect inspection apparatus using an optical simulator called a virtual stepper system (VSS) is also studied (see K. Ohira, et al., “Photomask quality assessment solution for 90-nm technology node”, Proceeding of SP1E Vol. 5446, pp. 364-374. 2004). In the VSS method, the mask image is returned to the design data once, and the wafer image is computed from the design data again, so that the computation becomes complicated and it takes a very long time to perform the computation. Theoretically it is impossible that the design data with defect is determined from the mask image having the defect measured simultaneously. Even if the VSS method is developed, it is readily understood that the computation becomes very complicated and the apparatus becomes expensive.

In the conventional defect inspection method, the pattern image is measured through the optical system in the apparatus to detect the defect. Therefore, the many false defects are generated in the patterns such as the OPC pattern, which increases the burden placed on the development of the defect detection algorithm. The many defects which do not actually become problematic on the wafer are detected even if the detection sensitivity is improved, which places the excessive burden on the subsequent process of correcting the defect. On the contrary, in the conventional defect inspection method, there is the problem that the defect which actually becomes problematic on the wafer pattern cannot be detected.

### SUMMARY OF THE INVENTION

An object of the invention is to provide a pattern defect inspection method and apparatus in which a pattern on a wafer is produced from the image obtained from the inspection apparatus and thereby the inspection can be performed by extracting only the defect which becomes problematic on an actual wafer.

The invention provides a method of fundamental solution with respect to the improvement of the defect detection sensitivity in the mask defect inspection apparatus, which conventionally becomes problematic. The masks having the various structures (for example, the mask to which the pattern having the special shape called optical proximity effect correction pattern: OPC pattern is added, the phase shift mask, and the like) are used in order to extend the resolution limit of the stepper. The problem with the necessity of the development of the defect detection algorithms that conform to the mask structures can be eliminated in the mask defect inspection. Conventionally, because design data capacity is largely increased by particularly adding the OPC pattern, the data handling becomes worse in the inspection apparatus, and the significant burden is placed on the control circuit which generates the image from the design data in the conventional way. The invention can also provide the inspection from the data of the pattern with no OPC pattern. In this case, it can be expected that the data handling is largely decreased.

The improvement of the detection sensitivity is incompatible with the decrease in false defect (the defect having no influence on the pattern formation on the wafer while regarded as the defect due to the inspection algorithm of the apparatus or a noise, or the minute defect considered to have no influence on the transfer) during the inspection. Currently the false defect is frequently generated near the OPC pattern. A huge amount of work for finding the many defects and confirming whether the defect is the false detect or not is required. Even the defect which has no influence on the wafer image is corrected, which generates the major obstacle to the subsequent correction process.

In the invention, because the inspection is performed with the wafer image, the inspection can be performed in consideration of the influence of the mask defect on the pattern on the wafer (mask error enhancement factor: MEEF). It is necessary that the inspection algorithm and the like be largely changed depending on the pattern dimension, a type of defect, and the mask structure such as a Cr mask and the phase shift mask (PSM). However, in the inspection performed with the wafer image, the algorithm can be simplified. That is, in the future inspection apparatus, although the improvement of the defect detection sensitivity is required, the comprehensively efficient inspection is performed in consideration of the influence of MEEF. Accordingly, the method of the invention is extremely effective.

An inspection wavelength near the stepper wavelength makes the wafer inspection more likely.

The method of the invention holds even in the apparatus which measures the wafer image in itself. Comparison is performed after the design data is correctly computed by the method determined from the theoretical formula of the optic, the inspection is performed by using the design data used for the production of the mask, and the inspection is performed by using both the two pieces of design data. Therefore, the inspection can effectively be performed while finding a mistake of the mask design data. Currently, only the method of exposing the pattern onto the wafer to perform the inspection is used as the final inspection in the OPC portion, so that it is thought that the method of the invention is extremely effective.

Examples of the well-known inspection method based on the wafer image include the method in which the inspection is performed with the device equal to the actual stepper optical system as described above and the method known as virtual stepper system in which the image obtained from the inspection apparatus is temporarily converted into the CAD data and then the wafer image is computed. In the former, because the wide-ranging stepper optical systems are required, it is difficult to prepare the stepper optical systems in the inspection apparatus. In the latter, it is difficult to perform the inspection at high speed (so-called in real time).

In one of the methods of the invention, while the wafer image is computed from the design data at high speed using a scalar diffraction theory (Fourier transform), the wafer image is directly computed from the image obtained by the actual mask defect inspection apparatus using the similar scalar diffraction theory, the wafer image obtained from the actual image is approximated to the wafer image obtained with high accuracy from the design data by appropriately performing the correction, and both the wafer images are compared to each other. Therefore, the invention provides the inspection method which solves the above-described problems.

At the same time, a method of setting a reference for obtaining an outline is provided as a defect comparison method. That is, the invention provides the method in which the defect is detected by simply comparing the outline of the wafer image from the design data and the outline of the wafer image from the measurement image. Unlike the conventional method, the invention provides the inspection method in which the complicated comparison algorithm such as light quantity comparison and derivative comparison is not required.

The invention adopts various inspection modes described below. However, basically the wafer image is used in the inspection.

A die-to-database inspection method is adopted as a first mode according to the invention. In an apparatus in which a measurement sample, in which a pattern is formed, is irradiated with an energy beam such as light and an electron beam, and detection optical system being able to detect transmitted energy beam or reflected energy beam from the measurement sample is provided to obtain a pattern image, design data of the pattern of the measurement sample and an image of the obtained image pattern are compared to each other to inspect a defect of the pattern formed in the measurement sample.

The measurement sample is a photomask (also referred to as reticle) used in producing the device. Design data of a design pattern produced in producing the photomask is used as the design data of the pattern, and it is characterized that the following procedure is performed in comparing the obtained image and the design data to perform the inspection.

The design data (also referred to as CAD data) is converted into an image (hereinafter referred to as wafer image) by a proper method, the wafer image is formed through a stepper used for actually forming the pattern of the photomask on a wafer, the obtained image actually measured is simultaneously converted into a wafer image by a proper method (in this case, the obtained data is not temporarily converted into CAD data), and the defect is detected by comparing both the images to each other. In the conventional method, the image observed with the inspection apparatus is formed from the design data. However, in the first mode of the invention, the stepper image is directly formed by a conversion formula. At the same time, the measurement image also forms the wafer image by the similar computing formula, and the defect is detected by comparing the stepper image and the wafer image formed from the measurement image. Therefore, the images in which the influence of the defect on the wafer is incorporated can be compared to each other to solve the above-described problem.

In a second mode according to the invention, a circuit design pattern graphic of the device is used as the design data of a die-to-database inspection. Generally, in order to correct an optical limit of the stepper, the optical proximity effect correction pattern is often added in producing the photomask. In the second mode, it is assumed that the design data of the pattern is compared to the obtained image to perform the inspection by using the design pattern in which the ideal pattern to be formed on the wafer is described. The stepper optical proximity effect correction pattern actually used in forming the pattern of the photomask on the wafer is not added to the ideal pattern. The design data is similarly converted into the wafer image formed with the stepper by the proper computing formula, the obtained image actually measured is simultaneously converted into the wafer image by the similar method, and the defect is detected by comparing the design data and the obtained image. In the first mode, when an error exists in the OPC pattern design, there is a drawback that the defect is not found even if the comparison is performed based on the design data. Accordingly, it is necessary that the inspection be performed with the original design data to which the pattern with OPC is not added. In this case, even if the computing formula for making the wafer image from the design data of the second embodiment is similar to that of the first embodiment, it is obvious that different parameters are used in the second mode. On the other hand, in the second mode, the method of determining the wafer image from the obtained image is similar to that of the first mode.

In a third mode according to the invention, the inspection is performed with the two above-described pieces of design data as the design data of die-to-database inspection. That is, the two pieces of design data include the pattern data with OPC which is of the design pattern produced in making the photomask and the original design data to which the stepper optical proximity effect correction pattern is not added. The third mode is the method in which the pieces of design data are converted into the wafer image by the proper method, the wafer images are compared to each other by using the measured obtained image and three kinds of the image data, and thereby the defect is detected. In the third mode, the mistake of the pattern with OPC becomes clear by comparing the pieces of design data to each other, and whether the defect derives the mask production or from the data can be known from the measurement pattern at the same time.

A fourth mode according to the invention adopts die-to-die inspection. The method of inspecting the wafer images is also efficiently used in the case where the pattern defect formed in the measurement sample is inspected by comparing repeated portions of the patterns. The fourth mode is the method in which the obtained image is converted into the wafer image using the proper computing formula and the defect is detected by comparing the wafer images. Therefore, the defect inspection is performed while the generation of the false defect is extremely suppressed. Since the same images are compared to each other at the same time, the inspection with high detection sensitivity and high accuracy can be expected compared with the die-to-database inspection.

In a fifth mode according to the invention, although it is assumed that the inspection method adopts the die-to-die inspection, the die-to-database inspection is partially introduced. In the method in which the pattern defect formed in the measurement sample is detected by comparing the image patterns in the repeated portions of the patterns, by using both the design pattern (pattern with OPC) produced in making the photomask and the original design pattern which is used in actually forming the pattern of the photomask on the wafer and to which the stepper optical proximity effect correction (OPC) pattern is not added, the pieces of design data are converted into the wafer images by the proper method based on the computing formula, and, in one point of the repeated pattern areas, the pattern with OPC is compared to the two kinds of design data or the pieces of design data are compared to each other. Then, the difference is obtained between the obtained image data and the design data to recognize the difference between the obtained image and the design data. Then, the defect is detected by comparing the obtained images (die-to-die inspection). Because the repeated defect cannot be detected in the die-to-die inspection, it is necessary that the obtained image be compared to the design data (die-to-database comparison) once somewhere. However, the die-to-database comparison often has a limit in the detection sensitivity, and an inspection time is lengthened depending on the design data capacity. In the die-to-die inspection, because the same images are compared to each other, it is possible to expect the improvement of the detection sensitivity, and inspection reliability is improved only when the wafer image is compared to the design data once. In the fifth mode, because presence or absence of the defect exists in the first design data comparison, it is necessary that the image in which the defect does not exist is found by various methods. The method of finding the defect is also studied in the conventional die-to-die inspection method, so that the same method can be adopted. That is, the invention can provide the inspection method in which the false defect is decreased by performing the wafer image inspection in the above-described manner and the burden is not placed on the subsequent process.

In a sixth mode according to the invention, approximate calculation and computing formula derived from a scalar analytic theory are combined to determine the wafer image, and the inspection is performed in real time during obtaining the image (in the middle of pattern inspection). Therefore, the industrially effective mask defect inspection apparatus can be provided.

In a seventh mode according to the invention, a method completely different from the above inspection method of the invention is adopted. That is, after the defect is detected by the completely different method, judgment of the defect is made by determining the wafer image with the above calculating method in the vicinity of an area where the defect is detected. The completely different method means the conventional defect detection. The defect portion is detected in a manner different from the method of the invention, and the defect is selected by the method of the invention. Therefore, the false defect is eliminated.

An eighth mode of the invention is an applied example of the seventh mode. Either a case in which the image of the defect area is actually re-obtained to perform the inspection because the wafer image inspection is performed after the defect portion is recognized or a case, in which the defect area is stored in a storage device when the defect is recognized and the already recognized defect area is read from the storage device to perform the wafer image inspection in an off-line operation, can be selected when the inspection is performed by determining the wafer image.

In a ninth mode according to the invention, at least means for inputting pattern information and pattern phase information on the design of the measurement sample and a pattern structure (material, position information on phase pattern, and the like) and means for inputting a stepper apparatus recipe (optical performance such as NA and wavelength, exposure conditions such as a lighting method and focus, and the like) are included in order to determine the wafer image from the design data or the obtained image using the computing formula. First, based on the pieces of information from the input means, the first wafer image is computed from the design pattern using the computing formula. Then, the second wafer image is computed from the image obtained from the inspection apparatus by the computing formula using the information from the input means, correction phase information, and gain and offset information. Then, a gain and offset difference is determined between the first wafer image and the second wafer image in order to perform fine adjustment, the gain and offset difference is applied to the second wafer image, and the second wafer image is determined from the obtained image by performing fine adjustment such that the first wafer image and the second wafer image coincide with each other. The wafer image can substantially analytically be determined from the design pattern using a scalar diffraction theory. However, an approximation is required in order to determine the wafer image from the image of the inspection apparatus. The inventors found that the wafer image determined from the measured inspection image can be caused to coincide substantially with the wafer image determined from the design data by inserting various procedures depending on the mask structures. That is, in the pattern such as the Cr pattern, in which a phase term is not taken into account, there is no problem. On the other hand, for the mask such as the phase shift mask which is designed to cause a light shielding film to generate a phase change in itself, in the case where the wafer image is computed from the obtained image, it is found that the good coincidence is obtained between the wafer image and the design data by inputting the correction phase term. A procedure of computing the wafer image through the above operation is required. In a light quantity profile, it is found that a gain and offset difference is generated between the case in which the light quantity profile is determined from the design data and the case in which the light quantity profile is determined from the measurement data, and the gain and offset difference can be determined in the simplified manner by a pattern structure function. A considerable degree of coincidence can be expected by determining the gain and offset difference to perform the correction. However, because the correction is not complete, after the analytically determined correction is performed, in order to perform fine adjustment, it is necessary that the correction be performed again by determining the gain and offset difference from the comparison result of design data and the measurement data. This enables the relatively accurate wafer image to be determined at high speed from the measurement image.

A tenth mode according to the invention is characterized in that the first wafer image determined in the ninth mode and the second wafer image are compared by the conventional inspection technique. The pattern defect is detected by determining the light quantity difference or the derivative difference based on the light quantity profiles.

In an eleventh mode according to the invention, line widths are at appropriate levels (threshold levels) in the light quantity profiles of the first wafer image and the second wafer image. In other words, a contour line of the pattern is determined to obtain an outline graphic having an appropriate height. The eleventh mode is characterized in that the first outline from the design data and the second outline from the obtained image are determined from the image outlines, and the pattern defect of the measurement sample is detected by comparing the first outline and the second outline to each other. In the tenth mode, the comparison is performed by using the troublesome technique such as the light quantity difference and the derivation. However, in the eleventh mode, the defect can be detected only by computing the difference in outline between the first outline and the second outline, i.e., a distance between the first outline and the second outline. Because various techniques are proposed as the outline determination technique, the eleventh mode can adopt these techniques.

In a twelfth mode according to the invention, in order to determine the threshold of the eleventh mode, the inspection is performed by inputting appropriate levels of image intensity profiles of the first wafer image and the second wafer image respectively before performing the inspection, the threshold level of the first wafer image coinciding with a pattern line width of the original design data before the first wafer image is determined or part of design data is determined, the threshold level of the second outline of the second wafer image is similarly determined, and the inspection is performed by inputting this value (setting the value to the apparatus) to determine the first outline and the second outline. Because it is necessary that the threshold be set before the inspection is started, easiness of the defect detection depends on the setting of the threshold. Sometimes it is necessary that the setting be changed depending on the mask structure, and the setting is often determined depending on the exposure conditions and development conditions of the stepper not on the inspection side but on the side which asks the inspection.

In a thirteenth mode according to the invention, examples of the specific methods are defined in order to determine the threshold of the twelfth mode. In this case, (a) an inspection method of performing an operation on the whole inspection area to determine the threshold level at which an error is minimized, (b) an inspection method to determine pattern fineness by changing the threshold level in a range according to the pattern fineness, (c) a method of appropriately specifying a proper area through an operator beforehand to set the threshold level (fineness may be specified), or (d) a method of changing the threshold level according to a pattern structure may be selected, when the threshold level of the first outline or the second outline of the first wafer image or the second wafer image is determined, the first or the second outline of the first wafer image or the second wafer image coinciding with a pattern line width of design data before the first wafer image is determined. The first wafer image and the second wafer image seldom coincide with each other in the whole surface of the mask, and it is easily thought that the threshold level is changed by the pattern structure, the pattern dimension, and the like. The thirteenth mode provides the inspection method which can deal with such the cases.

In a fourteenth mode according to the invention, it is assumed that the measurement object is already formed in the wafer pattern. In the above modes, it is assumed that the mask image is measured. However, in the fourteenth mode, it is assumed that the die-to-database inspection is performed by the wafer inspection apparatus with the electron beam such as SEM or an optical wafer inspection apparatus. At least means for inputting pattern information and pattern phase in formation on the design of the measurement sample and a pattern structure (material) is required, and means for inputting a stepper apparatus recipe (optical performance such as NA and wavelength, exposure conditions such as a lighting method and focus, and the like) is also required. The first wafer image is computed from the design pattern based on the pieces of information from the input means. Then, as described above, the gain and offset adjustment is performed between the first wafer image and the measurement image. The first image outlines and the second image outlines are determined at proper levels (threshold levels) of the image intensity profiles of the first wafer image and the measurement image, and the pattern defect of the measurement sample is detected by comparing the first outlines and the second outlines respectively. In this case, the method of determining the threshold level can adopt the contents shown in the twelfth mode and the thirteenth mode.

### BRIEF DESCRIPTION OF THE DRAWINGS

FIG. 1 shows a concept of basic inspection according to an embodiment of the invention, particularly shows an embodiment of an inspection system diagram in a mask defect inspection apparatus;

FIG. 2 shows comparison of a result in which a wafer image focused through an actual stepper is computed from design data according to a technique of the invention shown in an upper left and a result in which the wafer image is computed in the case where an image observed with the inspection apparatus is determined to transfer the image through the stepper;

FIG. 3 shows a result in which the image is obtained with the actual mask defect inspection apparatus to perform computation through an operation procedure shown in FIG. 1;

FIG. 4 shows an example of a case in which a defect is not found out by the comparison of profiles as shown in FIG. 3, but the defect is found out by determining outlines to detect difference between the outlines;

FIG. 5 shows a system conceptual view of the apparatus;

FIG. 6 shows a configuration example of a pattern defect inspection apparatus which perform pattern inspection by comparing design data of a mask used for producing a large-scale LSI to measurement data of the mask; and

FIG. 7 shows an example of the pattern formed in the mask in the defect inspection apparatus of FIG. 6.

### EMBODIMENTS

Plural embodiments of the invention will be described below with reference to the drawings.

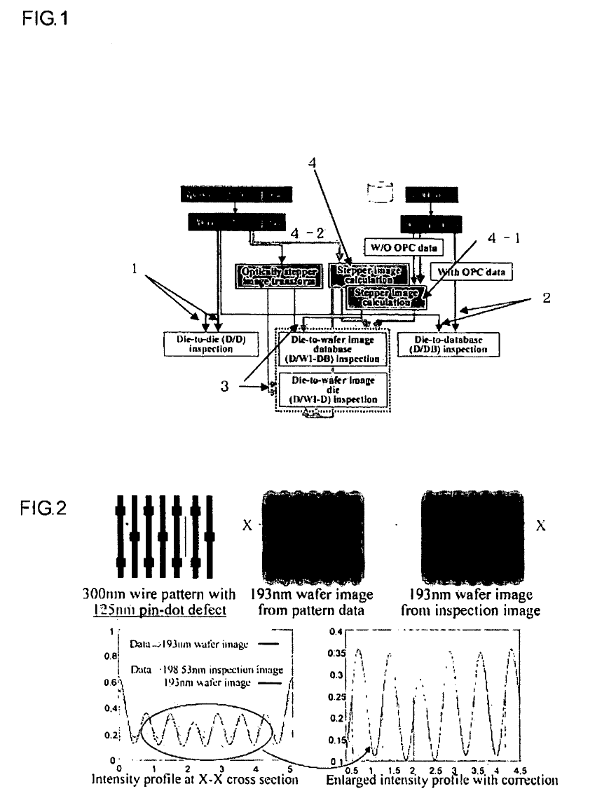

FIG. 1 shows a concept of basic inspection according to an embodiment of the invention, particularly shows an example of an inspection system diagram in a mask defect inspection apparatus.

In the case of the inspection of the images adjacent to each other (die-to-die inspection), the inspection is performed by the flow of “1” shown in FIG. 1 with respect to the image measured by the inspection apparatus. In the case where the image is compared to the design data (die-to-database inspection), the inspection is performed through a route shown by “2”, the design data is expanded to a bit image, the bit image is processed with a proper filter expressing characteristics of the inspection optical system (basically the optical system can be expressed by the filter in which inverse Fourier transform is performed to the characteristics shown by MTF) to form the image close to the measurement image, and the image is compared to the measurement image. However, the following problems become clear in such the inspections:

(1) It is said that even the minute defect of the mask has the large influence on the pattern formation in the transfer image of the stepper. Therefore, the improvement of the defect detection sensitivity is demanded for the mask defect inspection apparatus.

(2) The resolution limit of the stepper is extended by the masks having the various structures (for example, a mask having a pattern in a particular form called optical proximity effect correction pattern: OPC pattern, a phase shift mask, and the like). Therefore, in the mask defect inspection, it is necessary to develop defect detection algorithms that conform to the mask structures.

(3) Because the design data capacity is largely increased by the addition of the OPC pattern, the data handling becomes worse in the inspection apparatus, and the significant burden is placed on the control circuit which generates the image from the design data in the conventional way.

(4) In the conventional inspection apparatus, the inspection is performed with the wavelength far away from that of the stepper. Therefore, it is impossible to ensure that the accurate inspection is performed.

(5) The improvement of the detection sensitivity is incompatible with the decrease in false defect (the defect having no influence on the pattern formation on the wafer while regarded as the defect due to the inspection algorithm of the apparatus or the noise, or the minute defect considered to have no influence on the transfer) during the inspection. Currently, the false defect is frequently generated near the OPC pattern, which generates the major obstacle to the subsequent correction process.

(6) The influence of the defect on the pattern image on the wafer is also called mask error enhancement factor (MEEF). It is found that MEEF is largely changed according to the pattern dimension, the type of defect, and the mask structure such as the Cr mask and the phase shift mask (PSM). Therefore, although the improvement of the detection sensitivity is required, it is found that the comprehensively efficient inspection is performed in consideration of the influence of MEEF.

Therefore, the inspection is efficiently performed with the actually transferred image. The method, in which the optical system having the same wavelength as the stepper is provided in the inspection apparatus and the wafer image is directly formed to perform the inspection, is also proposed in order to solve the above problems. In this case, the flow of the inspection is shown by the route 3. However, in this method, a continuous emission laser having the wavelength, e.g., corresponding to the 193-nm stepper is not available as the light source suitable for the inspection apparatus, and there are many development items for implementing the inspection apparatus. There is also the problem that optical systems corresponding to all the steppers are prepared.

In the invention, the method shown by the flow of a route 4 in FIG. 1 is adopted as the inspection method which can be applied to the newly developed inspection apparatus having the wavelength of 198.5 nm. That is, in this method, there is a route 4-1 in which the wafer image is computed from the design data by the computation using a stepper recipe. In the route 4-1, various stepper recipes used in the actual transfer are inputted to form the wafer image by the computation (the computation method will be described later). It is possible that the graphic of the circuit pattern is used as the design data, or it is possible that the pattern used in making the mask is used as the design data. Recently, in the case where the mask is made, the correction pattern (OPC pattern) is often added in consideration of the optical proximity effect of the stepper. The pattern with OPC may be used as the design data. However, in the computation, it is necessary to determined whether the design data is the circuit design pattern or the mask pattern.

On the other hand, there is a route 4-2 in which the image is computed from the inspection apparatus having the wavelength of 198.5 nm. In the route 4-2, the wafer image is also computed from the measurement image using the stepper recipe. Various assumptions are used in the computation process, and basically a phase characteristic assumption and an offset and gain adjustment are included in the computation process. The method, in which the mask image is temporarily returned to the design data and the wafer image is computed from the design data again, is not adopted. Therefore, the computation is very simplified, the apparatus cost can be reduced. Thus, the die-to-database inspection can be performed with the design data, and the die-to-die inspection can also be performed by converting the observation images into the wafer images. In the die-to-database inspection, the inspection can be performed using the wafer image (in this case, the computation for performing a development process is not included, and the wafer image is a spatial image called Arial image). The inspection can be performed by selecting the die-to-database inspection or the die-to-die inspection as necessary.

FIG. 2 shows the comparison of the result in which the wafer image focused through the actual stepper is computed from the design data according to the technique of the invention shown in the upper left and the result in which the wafer image is computed in the case where the image observed with the inspection apparatus is determined to transfer the image through the stepper.

FIG. 2 shows the pattern in which the 125 nm-size defects exist. An ArF halftone type phase shift mask (line width: 300 nm, transmittance: 15%) is used as the pattern. The lower left of FIG. 2 shows the comparison of the wafer image from the pattern data and the wafer image from the inspection image, and the left of FIG. 2 shows the light quantity profile at a cross section taken on line X-X of the images shown the upper portion of FIG. 2. The wafer image from the pattern data and the wafer image from the inspection image differ from each other in amplitude and an absolute height of the light quantity. The difference in amplitude and the difference in height can theoretically be derived to some extent using a pattern structure function. However, because the wafer image from the pattern data and the wafer image from the inspection image cannot completely coincide with each other by this operation, it is necessary that the gains and the offsets be suited to each other by performing the computation such that the pattern profiles of the wafer image from the pattern data and the wafer image from the inspection image coincide with each other as much as possible. It is also necessary that the gains and the offsets be previously adjusted with the pattern in which the defect is presumably absent. It is also possible to perform the operation for decreasing the difference in two waveforms obtained in FIG. 2 on the assumption that the small number of defects exists. The lower right of FIG. 2 shows the coincidence of the profiles of the wafer image determined from the design data and the wafer image determined from the image of the inspection apparatus after the above-described operation. In the case where the wafer image is determined from the measurement image, obviously the computation is performed while the phase characteristic assumption is incorporated as described above. As can be seen from the lower right of FIG. 2, there is the relatively good coincidence between the wafer image from the pattern data and the wafer image from the inspection image.

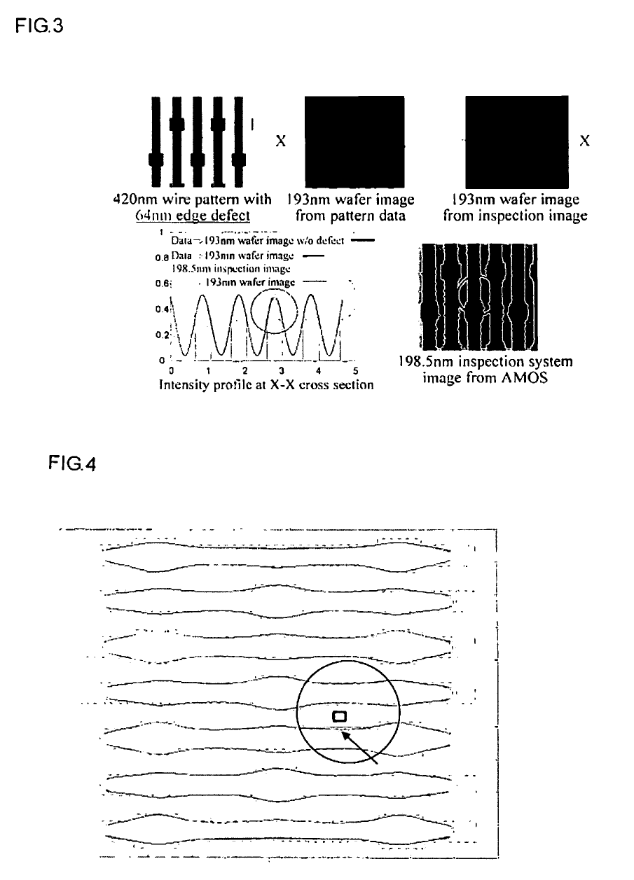

FIG. 3 shows the result in which the image is obtained with the actual mask defect inspection apparatus to perform the computation through the operation procedure shown in FIG. 1. FIG. 3 shows the 64-nm edge defects. The ArF mask having the shape similar to FIG. 1 while the line width is 400 nm. The lower left of FIG. 3 shows the result of the wafer image from the pattern data and the wafer image from the inspection image. For the purpose of verification, FIG. 3 shows the result in which the wafer image is determined from the design data in the case of no defect and the result in which the wafer image is determined in the case where the defect is added to design data. In the case where the defect is not found in the actual inspection, the wafer image from the design data and the wafer image from the inspection apparatus are compared to find the defect. As can be seen from FIG. 3, there is the slight difference between the wafer image from the design data and the wafer image from the inspection apparatus.

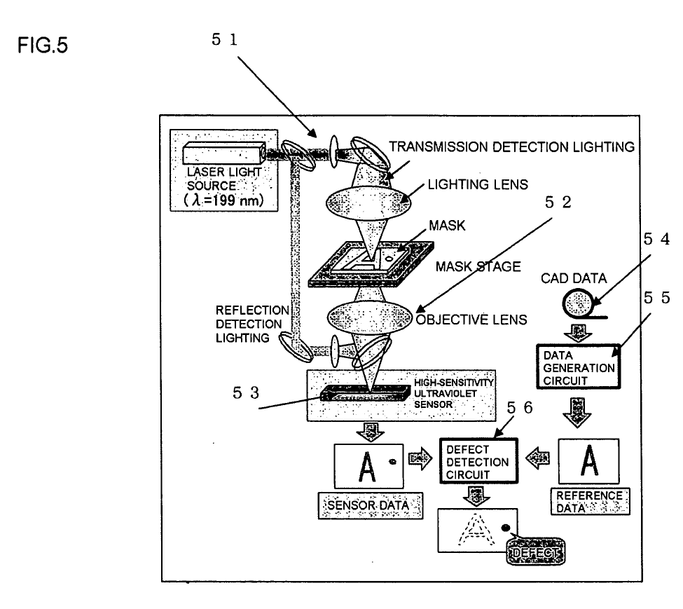

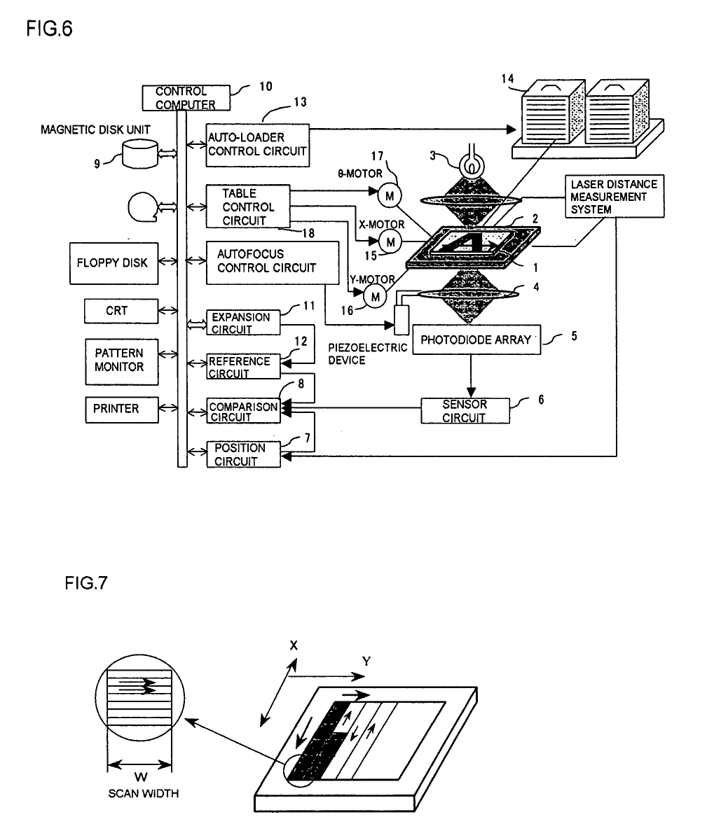

FIG. 4 shows an example of the case in which the defect is not found out by the comparison of the profiles as shown in FIG. 3, but the defect is found out by determining the outlines to detect the difference between the outlines.

In FIG. 4, the graphic of the design data is shown by a thin broken line. When the profile with no defect is determined to obtain the outline at the proper height of the light quantity, the outline close to FIG. 4 is obtained. The difference is determined between this outline and the graphic of the design pattern to find the light quantity height (threshold) where the good coincidence is obtained between this outline and the graphic of the design pattern, and an outline is determined at the light quantity height (threshold). FIG. 4 shows the result. However, in this case, it is necessary to determine the pattern which is of a reference. For example, in the case shown in FIG. 4, it is found that introduction of another idea is required to perform the comparison of the differences at a corner. Therefore, the outline is not determined from the comparison at the corner, but the outline is determined based on the outline of the line for example. FIG. 4 shows the result in which the outline is actually determined based on the outline of the line. In FIG. 4, a square portion shows that a pin-dot defect exists therein. The arrow portion of the outline shows that the difference is generated between the outline with no defect and the outline in which the wafer image is determined by the image from the mask inspection apparatus.

Thus, the defect inspection performed by determining the wafer image from the mask inspection image includes the case in which the usual light quantity profile waveform is computed to perform the inspection by the die-to-database method or the die-to-die method and the method of determining the light quantity profile cross section (so-called outline) with the proper threshold. Particularly, since uniformity of the line width (CD uniformity) is mainly discussed in the defect on the wafer, the outline comparison is more suitable to the discussion of the CD uniformity. In the case of the outline comparison, the inspection algorithm becomes simplified.

The inspection is performed in consideration of the influence of the on-mask defect on the wafer pattern formation by the inspection with the wafer image, which allows the false defect problem to be solved. Therefore, the working can largely be decreased in the subsequent correction process.

FIG. 5 shows a system conceptual view of the apparatus. A mask defect inspection apparatus 51 irradiates the mask in which the pattern is formed with a light energy beam, and the mask defect inspection apparatus 51 measures the transmitted light from the mask. Although the reflected light may be used, the transmitted light is used in the mask defect inspection apparatus 51 shown in FIG. 5. The image is obtained through a detection optical system 52. The image of the continuously moving mask may be obtained, or the still image of the mask may be obtained. Any type of image obtaining sensor 53 is used for obtaining the image. Design data 54 of the mask pattern is sent to a computation circuit 55 as graphic shape data. The computation circuit 55 sets separately inputted parameters to the circuit 55. The parameters include the pieces of information on the type and structure of the mask and the phase condition which are necessary to produce the mask and the information on the stepper recipe. The parameters are inputted by an operator, or the parameters are incorporated into the design data to be inputted into the apparatus. The wafer image is computed from the design data with the necessary parameters, and the wafer image is sent to a comparison circuit 56. On the other hand, the measurement image is sent to a similar computation circuit 57. The parameters necessary to the computation are set to compute the wafer image, and the wafer image is sent to a comparison circuit 56. Before the actual inspection is performed, the following calibrations are performed.

(1) The wafer images are derived from the design image and from measurement image of a particular area, phase correction means and the gains and offsets of the design image and measurement image are adjusted so as to coincide with the output from the design data. In this case, the adjustment is obviously performed by using the pieces of information on the mask structure, the phase characteristic, and the stepper. The adjustment is performed in the plural areas at the same time if necessary. Sometimes a table in which comparison is previously established with the defect is provided in the correction means.

(2) In the case where the outline inspection is performed, the light quantity threshold of the line width which is caused to coincide with the line width of the design value is determined. The case in which the threshold is determined by the input value of the operator is also included. The threshold determined from the design data and the threshold determined from the inspection image may independently be set, or threshold determined from the design data and the threshold determined from the inspection image may be set at the same value. The threshold determined from the design data and the threshold determined from the inspection image may be changed in the various areas described in (1).

(3) A comparison level is set in the comparison circuit.

The inspection is performed according to the above procedures (1) to (3).

The case of the die-to-database inspection is shown in the above example. In the case where the graphic of the device design circuit pattern is used as the design data, or in the case where the optical proximity effect correction pattern (OPC pattern) is added in order to correct the optical limit of the stepper, either the wafer images from the design image or the wafer image from measurement image can be used, or both the wafer images from the design image and the wafer image from measurement image can be used. The procedures can be changed according to the purpose of the inspection. That is, both the wafer images from the design image and the wafer image from measurement image are obviously required in the inspection whether the mistake exists in the design of the OPC pattern or not. In the case where the two kinds of data are used, two computation circuits 55 are required.

In the case of performance of the die-to-die inspection which is of the method of comparing the repeated portions of the patterns to each other to inspect the pattern defect formed in the mask, the measurement image is inputted into the computation circuit 55. It is obviously necessary that the parameters are changed in order to compute the wafer image from the inspection image. The inspection method in which the die-to-database inspection is partially introduced is also performed as a modification of the die-to-die inspection. The conversion into the wafer image is performed with the design pattern (pattern with OPC) produced in making the mask and/or the original design pattern to which the stepper optical proximity effect correction (OPC) pattern is not added, and, in one point of the repeated pattern areas, the pattern with OPC is compared to the one or two kinds of design data or the pieces of design data are compared to each other (die-to-database inspection). Then, the difference is obtained between the obtained image data and the design data to recognize the difference between the obtained image and the design data. Then, the defect is detected by comparing the obtained images to each other (die-to-die inspection). The inspection can be performed only by changing the apparatus operation method and software without changing the system configuration shown in FIG. 5. The inspection can eliminate the lack of the repeated defect detection in the die-to-die inspection.

The inspection of the above apparatus is characterized in that the wafer image is determined to perform the inspection by combining the computing formula and approximation computation, derived from the scalar analytical theory, and the appropriate correction computation in real time during obtaining the image (in the middle of the pattern inspection). Therefore, the effective mask defect inspection apparatus can be provided from the industrial standpoint. However, according to the decision of the operator, sometimes the technique of the apparatus is applied only to defect portion, after the inspection is performed with the mask image to extract the defect by the conventional inspection method. In this case, basically the wafer image inspection system configuration of the apparatus is not changed. Further, it may be a convenient method that when the defect is once recognized, the defect area is stored in the storage device, and one case that the wafer image inspection is performed by offline operation while reading out the area of the defect portion from the storage device when the defect is recognized, and the other case that the wafer image inspection is not performed, both cases can be selected.

In order to determine the wafer image from the mask design data or the obtained image by the computing formula, it is necessary to input at least the design pattern information and pattern phase information of the measurement sample, the pattern structure (material, phase pattern position information, and the like), and the stepper apparatus recipe (optical performance such as NA and wavelength, exposure conditions such as a lighting method and focus, and the like). The computation is performed with the basic formula (1) generally known.

wherein Dmm is a coefficient obtained by Fourier transform of the design data.

In this case, the data for a polygon coordinate display may be used as the design data input, or the design data may be converted into the bit image once and inputted. In the case where the design data is inputted from the measurement image, it is obvious that the design data is inputted from the bit image. Generally, when commercially available 3-GHz clock CPU is used, it takes several second to perform the computation of 512-by-512 pixels. However, this computation speed is not practical. When a special circuit is formed in hardware to perform the computation, the speed can easily be increased about 100 times. For example, when the 150 mm-by-150 mm area is inspected in inspection unit of 100-nm pixel size, the following process is required:
150×150×10⁶(μm)×10⁶(nm)/100×100(nm)=2.25×10¹²(pixel)
For example, when the 150 mm-by-150 mm area is inspected with the image obtaining sensor having speed of 400 M pixels/s, the inspection time is obtained as follows:
2.25×10¹²(pixel)/400×10⁶(pixel/s)=2.5×10³(s)
Therefore, the inspection can be performed within an hour. When the inspection unit is 70-nm pixel size, the inspection time is substantially doubles. When the inspection unit is 50-nm pixel size, the inspection time becomes four times. On the other hand, when it takes five seconds to perform the computation of about 512-by-512 pixel area, the inspection time is obtained as follows:
2.25×10¹²(pixel)/512×512(pixel/5 s)=4.3×10⁸(s)
It takes an awful long time. However, a ratio of the inspection time of 2.5×10³(s) to the computation processing time of 4.3×10⁸(s) is about 2×10⁵. When the computation processing time is decreased 1/100 times by the hardware circuit, the ratio of the inspection time to the computation processing time is about 2×10³. When the 1000 circuits are arranged in parallel, the computation can be performed in real time. The computation technique using such special circuit is commercially available (already reported in SPIE 2005 and the like), so that the method of the invention can be performed.

Then, there will be shown the thought, in which, after the wafer image is computed from the design pattern by the computing formula, the wafer image is computed from the image obtained by the inspection apparatus by the computing formula based on the information from the input means, correction phase information, and the gain and offset information, the gain and offset difference is determined from the wafer images 2 of the design pattern and the obtained image in order to perform the fine adjustment, and the gain and offset difference is applied to the wafer image determined from the inspection image to cause the wafer images to coincide with each other.

For the sake of convenience, the light quantity is shown by a linear computation in the case where the wafer image is determined from the optical theoretical formula. Assuming that π is the phase change amount in light shielding portion used in the ArF lithography and the phase mask has the 6% transmittance, the following relationship is obtained in zero-order and ±1-order diffraction light beams when the ratio of the light shielding portion to the light transmitted portion is 1:1.
C₀=−C_{±1}

When the wafer image is approximately formed by interference of zero-order and ±1-order, the light quantity of the wafer image is obtained as shown by the formula (2).

In the case where the wafer image is determined from the mask image, basically the image is determined from the wafer image determined from the mask image again through the optical system. When the mask image is approximately formed by the interference of the zero-order and ±1-order, complex amplitude of the mask image is given by the formula (3). Because the phase information cannot be obtained from the mask image, the influence of the phase is neglected here. The mask is dealt with by the formula (4).

Therefore, the zero-order and ±1-order diffraction light beams are given by the formula (5).

When the wafer image is approximately formed by the interference of the zero-order and ±1-order, the light quantity of the wafer image is obtained by the formula (6).

The above two equations for obtaining the light quantities of the wafer images differ from each other in the coefficient and a slight harmonic component. The difference in coefficient becomes the gain difference between the wafer images, and the difference in coefficient depends on the mask structure function. When the mask structure function is substituted in the linear equations for obtaining the light quantities of the wafer images, it is found that the wafer images coincide with each other to a large degree. It is expected that the coincidence is obtained to a large degree by determining the mask structure function to perform the correction. However, because the correction is not complete, it is necessary that the gain and offset difference is determined from the comparison result between them to perform the correction again in order to perform the fine adjustment after the analytically determined correction is performed.

In order to determine the wafer image from the image of the inspection apparatus, the wafer image is determined by performing the approximation as shown by the above equation. This is because the slight harmonic components are different from each other in the results. In the pattern such as the Cr pattern in which the phase term is not taken into account, there is comparatively no problem. On the other hand, for the mask such as the phase shift mask which is designed to cause the light shielding film to generate the phase change in itself, in the case where the wafer image is computed from the obtained image, it is found that the good coincidence is obtained between the wafer image and the design data by inputting the correction phase term. In inputting the correction phase term, it is necessary in any case that the range where the phase term of the actually observed image is considered is determined from the design data. The operation in which the range is correlated with the correction phase term is required. After the correlation, various methods can be thought in inputting the correction phase term. The case where the intensity of the obtained image is considered, the method in which the consideration is taken by the conversion into the amplitude, and the area where the correction phase term is considered can be changed in a various ways. It is also thought that the phase term is changed in association with the image intensity or the amplitude. The operation is changed in the various ways according to the mask structure (type), and the calibration to the actual image is required. However, the correction can be integrated by a considerably bold assumption.

The invention can be applied not only to the mask inspection but also to the case where the measurement object is the wafer pattern. For example, the invention can be applied to the die-to-database inspections of the wafer inspection apparatus with the electron beam such as SEM or the optical wafer inspection apparatus. However, at least the means for inputting the pattern information and the pattern phase information on the design of the measurement sample and the pattern structure (material) is required, and means for inputting a stepper apparatus recipe (optical performance such as NA and wavelength, exposure conditions such as a lighting method and focus) is also required. In this case, it is thought that the apparatus shown in FIG. 5 is replaced with the apparatus such as SEM or the optical wafer inspection apparatus. The wafer image is computed from the design pattern based on the pieces of information from the input means. Then, as described above, the gain and offset adjustment is performed between the wafer image and the measurement image. The image outlines are determined at proper levels (threshold levels) of the image intensity profiles of the wafer image and the measurement image, and the pattern defect of the measurement sample can be detected by comparing the respective outlines to each other. The method of determining the threshold level can adopt the various references and methods contents. In this case, the method of the invention differs from the conventional method in that the comparison is performed after the design data is correctly computed by the method determined from the theoretical formula of the optic at all times, the inspection is performed by using the design data used for the production of the mask, and the inspection can effectively be performed while finding a mistake of the mask design data by using both the two pieces of design data. Currently, only the method of exposing the pattern onto the wafer to perform the inspection is used as the final inspection in the OPC portion, so that it is thought that the method of the invention is extremely effective.

The input of the design data includes the following patterns:

(1) The ideal wafer pattern to be formed on the wafer, to which the stepper optical proximity effect correction pattern used in actually forming the pattern of the photomask on the wafer, is not added.

(2) The mask pattern to which the stepper optical proximity effect correction pattern used in actually forming the pattern of the photomask on the wafer is added.

(3) The ideal wafer pattern to be formed on the mask, to which the stepper optical proximity effect correction pattern used in actually forming the pattern of the photomask on the wafer, is not added.

The respective patterns may solely be imputed, or the plural pieces of data may be inputted. When the type of the inputted data is distinguished, the wafer image can be computed from the design data according to the contents thereof. These wafer images may individually be determined to change the contents of the inspection in various ways.

### List of Formulas

$$\begin{matrix}\begin{matrix}I ( X , Y ) = \int {\int }_{Σ} ⅆ {α}_{o} ⅆ {β}_{o} \\ {\vert {\sum }_{m} {\sum }_{n} {D}_{mn} exp \{ ⅈ ( {α}_{m} X + {β}_{n} Y + {γ}_{mn} Z ) \} \vert}^{2} \\ Λ ( 6 )\end{matrix} & Formula ( 1 ) \\ I ( x ) = {C}_{0}^{2} ( 1 - 4 cos x + 4 {cos}^{2} x ) & Formula ( 2 ) \\ {C}_{0} ( 1 - 2 cos x ) & Formula ( 3 ) \\ \vert {C}_{0} ( 1 - 2 cos x ) \vert & Formula ( 4 ) \\ {C}_{0}^{′} = \frac{1}{3} {C}_{0} ( 1 + 4 \frac{sin ( π / 3 )}{π / 3} ) = {FC}_{0} , \\ {C}_{\pm 1}^{′} = \frac{- 1}{3} {C}_{0} ( 1 + \frac{sin ( π / 3 )}{π / 3} ) = - {GC}_{0} & Formula ( 5 ) \\ I ( x ) = {C}_{0}^{2} [ {F}^{2} + FG ( - 4 cos x + 4 \frac{G}{F} {cos}^{2} x ) ] & Formula ( 6 )\end{matrix}$$

What is claimed is:

1. A method of irradiating a measurement sample to be measured with an energy beam, a pattern being formed in the measurement sample, detecting a transmitted energy beam or a reflected energy beam from the measurement sample, obtaining a pattern image, and comparing design data of the pattern and an image of the obtained image pattern so as to inspect a defect or defects of the pattern formed in the measurement sample,
wherein the measurement sample is a photomask,
wherein design data of a design pattern produced in producing the photomask is used as the design data of the pattern, and
wherein, during a procedure of performing inspection by comparing the obtained image and the design data, the design data is converted into a first wafer image by a proper method, the first wafer image being formed through a stepper used for actually forming the pattern of the photomask on a wafer, the obtained image actually measured is simultaneously converted into a second wafer image by a proper method, and the defect is detected by comparing the first wafer image and the second wafer image.

2. A method of irradiating a measurement sample to be measured with an energy beam, a pattern being formed in the measurement sample, detecting a transmitted energy beam or a reflected energy beam from the measurement sample, obtaining a pattern image, and comparing design data of the pattern and an image of the obtained image pattern to inspect a defect of the pattern formed in the measurement sample,
wherein the measurement sample is a photomask,
wherein design data of a design pattern is used as the design data of the pattern, an optical proximity effect correction pattern of a stepper being not added to the design pattern, the stepper being used for actually forming the pattern of the photomask on a wafer, an ideal pattern to be formed on the wafer being described in the design pattern, and
wherein, in a procedure of performing inspection by comparing the obtained image and the design data, the design data is converted into a first wafer image by a proper method, the first wafer image being formed through a stepper used for actually forming the pattern of the photomask on a wafer, the obtained image actually measured is simultaneously converted into a second wafer image by a proper method, and the defect is detected by comparing the first wafer image and the second wafer image.

3. A method of irradiating a measurement sample to be measured with an energy beam, a pattern being formed in the measurement sample, detecting a transmitted energy beam or a reflected energy beam from the measurement sample, obtaining a pattern image, and comparing design data of the pattern and an image of the obtained image pattern to inspect a defect of the pattern formed in the measurement sample,
wherein the measurement sample is a wafer pattern,
wherein both design data of a design pattern produced in producing the photomask and design data of a design pattern, to which an optical proximity effect correction pattern of a stepper used for actually forming the pattern of the photomask on a wafer is not added and in which an ideal pattern to be formed on the wafer is described, are used as the design data of the pattern, and
wherein, in a procedure of performing inspection by comparing the obtained image and the design data, each piece of the design data is converted into a wafer image by a proper method, and the defect is detected by using three kinds of image data of the measured obtained image to compare one another.

4. A method of irradiating a measurement sample with an energy beam, a pattern being formed in the measurement sample, detecting a transmitted energy beam or a reflected energy beam from the measurement sample, obtaining a pattern image, and comparing the image patterns in repeated portion of the obtained pattern to each other to inspect a defect of the pattern formed in the measurement sample,
wherein the measurement sample is a photomask, and
wherein the obtained image is converted into a wafer image by a proper conversion method, and the defect is detected by comparing the obtained image and the wafer image.

5. A method of irradiating a measurement sample with an energy beam, a pattern being formed in the measurement sample, detecting a transmitted energy beam or a reflected energy beam from the measurement sample, obtaining a pattern image, and comparing the image patterns in repeated portion of the obtained pattern to each other to inspect a defect of the pattern formed in the measurement sample,
wherein the measurement sample is a wafer pattern,
wherein both design data of a design pattern with an optical proximity effect correction pattern produced in producing the photomask and design data of a design pattern, to which the optical proximity effect correction pattern of a stepper used for actually forming the pattern of the photomask on a wafer is not added and in which an ideal pattern to be formed on the wafer is described, are used, and
wherein each piece of the design data is converted into an wafer image by a proper method, the two kinds of design data are compared to each other in the obtained image of one point of a repeated pattern area, difference between the obtained image data and the design data is determined, and the defect is detected by comparing the obtained images to each other.

6. A method of detecting a defect according to claim 1, wherein, in said inspection method, the inspection is performed by determining the wafer image in real time during obtaining the image in the middle of pattern inspection.

7. A method of detecting a defect according to claim 1, wherein, in said inspection method, after the defect is detected by a completely different method, the inspection is performed by determining said wafer image near an area where the defect is detected.

8. A method of detecting a defect according to claim 7, wherein either a method of performing the inspection by actually re-obtaining the image or a method of performing the inspection by using the obtained image of a defect portion already stored in a storage device can be selected in performing the inspection by determining the wafer image.

9. A method of detecting a defect according to claim 1, wherein at least means for inputting pattern information and pattern phase information on the design of the measurement sample and a pattern structure (material) and means for inputting a stepper apparatus recipe (optical performance such as NA and wavelength, exposure conditions such as a lighting method and focus) are included in order to determine the wafer image from said design data or the obtained image, and
wherein the first wafer image is computed from the design pattern based on the pieces of information from said input means, the second wafer image is computed from the image obtained from the inspection apparatus by using the pieces of information from said input means, correction phase information, and gain and offset information, a gain and offset difference is determined between the first wafer image and the second wafer image in order to perform fine adjustment, the gain and offset difference is applied to the second wafer image, and the second wafer image is determined from the obtained image by performing fine adjustment such that the first wafer image and the second wafer image coincide with each other.

10. A method of detecting a defect according to claim 1, wherein the pattern defect of the measurement sample is detected by comparing the first wafer image and the second wafer image.

11. A method of detecting a defect according to claim 1, wherein a first image outline and a second image outline are determined at appropriate levels (threshold levels) of image intensity profiles of the first wafer image and the second wafer image, and the pattern defect of the measurement sample is detected by comparing the first outline and the second outline.

12. A method of detecting a defect according to claim 11, wherein a function of performing the inspection by inputting appropriate levels of image intensity profiles of the first wafer image and the second wafer image or a threshold level of the second outline of the first wafer image or the second wafer image is determined before performing the inspection, the second outline of the first wafer image or the second wafer image coinciding with a pattern line width of a part of pieces of design data before the first wafer image is determined, and the inspection is performed by inputting this value to determine the first outline and the second outline.

13. A method of detecting a defect according to claim 12, wherein (a) an inspection method of performing an operation on the whole inspection area to determine the threshold level at which an error is minimized, (b) an inspection method of determine pattern fineness to change the threshold level in a range according to the pattern fineness, (c) a method of appropriately specifying a proper area to set the threshold level, or (d) a method of changing the threshold level according to a pattern structure is used, when the threshold level of the first outline or the second outline of the first wafer image or the second wafer image is determined, the first or the second outline of the first wafer image or the second wafer image coinciding with a pattern line width of a part of pieces of design data before the first wafer image is determined.

14. A method of detecting a defect according to claim 3, wherein at least means for inputting pattern information and pattern phase information on the design of the measurement sample and a pattern structure (material) and means for inputting a stepper apparatus recipe (optical performance such as NA and wavelength, exposure conditions such as a lighting method and focus) are included, and
wherein the first wafer image is computed from the design pattern based on the pieces of information from said input means, first image outlines and second image outlines are determined at proper levels (threshold levels) of the image intensity profiles of said first wafer image and the measurement image, and the pattern defect of the measurement sample is detected by comparing the first outlines and the second outlines respectively.

15. A method of detecting a defect according to claim 1, wherein the first wafer image is computed using a scalar diffraction theory, and having processes that an intensity distribution area or an amplitude area of the measurement image corresponding to the area where the phase information to be concerned with the pattern structure is identified from an intensity distribution determined as a computation result of the scalar diffraction theory and the pattern structure and the phase information given as the design pattern information, a width to be identified is determined, the phase distribution is arbitrarily set in the area, and thereby the second wafer image is computed using the scalar diffraction theory.

16. A method of detecting a defect according to claim 1, wherein the wafer image is computed by inputting a phase distribution in a rectangular shape or the wafer image is computed by changing the phase in proportion with image intensity or amplitude intensity, during a procedure of arbitrarily setting the phase distribution in an intensity distribution area or an amplitude identified area of said measurement image.

17. A method of detecting a defect according to claim 1, wherein a wavelength of 198.5 nm is used for the mask defect inspection when ArF lithography (wavelength: 193 nm) is used.
